(19) United States
(12) Patent Application Publication
(10) Pub. No.: US 2013/0192131 A1
(43) Pub. Date: Aug. 1, 2013

(54) DESALINATION GREENHOUSE

(71) Applicant: Mansur Abahusayn, Irvine, CA (US)

(72) Inventor: Mansur Abahusayn, Irvine, CA (US)

(21) Appl. No.: 13/359,493

(22) Filed: Jan. 26, 2012

(51) Int. Cl. A01G 9/18

(52) U.S. Cl. 47/17

(57) ABSTRACT

A desalination greenhouse of the invention provides both winter and summer crop growing operations and to produce a source of potable water given an input of only brackish or sea water. A consistency of temperature is produced by insulation and compensating absorption of heat in summer, with the release of heat in winter to keep crops more isothermal, but without obstructing natural light transmission to the crops. A very thin layer of brackish or salt water is evaporated from an inner shell and condensed onto an outer shell. Supplemental heat exchange can be applied to cool water used for crop irrigation.

### FIELD OF THE INVENTION

The present invention relates to improvements in water efficient greenhouses for efficient growth of agricultural produces and more particularly to a renewable energy desalination greenhouse which can utilize seawater or brackish water to perform a desalination process which, using renewable energy, grows crops in a shorter time period while using only a small fraction of the water which would otherwise be utilized in open field production. The present invention is also shown to be amenable to automated and continuous agricultural production.

### BACKGROUND OF THE INVENTION

In arid areas of the world a conventional greenhouse has a number of disadvantages. Increased sun light can cause a greenhouse to overheat. The answer to overheating has been to open the greenhouse to a cross breeze and increase evaporation for cooling. However, in desert areas this simply translates into a prohibitively greater water usage than would be experienced with the greenhouse in cooler climates. A conventional greenhouse project in the desert would normally require a commitment of several multiples of the amount of water than would be necessary in a cooler climate. Conventional greenhouses contemplate fresh water to be applied to plants in an amount to not only provide a nourishment medium for the plants, but also to humidify the internal space within the greenhouse. However, the internal space within the greenhouse must not over heat, and the main mechanism to prevent overheating is to create a cross draft of outside air to cool. However, this cooling evaporates and dehumidifies the interior growing space of the greenhouse.

The desert environment is well known to have very little fresh water available, or perhaps only sea water, brine from groundwater desalination plants or brackish water available. Such desert environment is also known to have high solar availability, but suffers from excess temperatures associated with the intense solar exposure. The shortcomings of the conventional or more advanced solar still design, where water in an enclosure with a sun facing inclined transparent cover condenses desalinated water on the inside of the cover for collection. Its heat input may be increased by mirrors in order to increase yield of desalinated water per square meter of cover per day, however the original simple solar still and its many variations suffer from the following shortcomings: (1) when the solar still is dedicated for desalination only the cost of the structure becomes very expensive and so does the desalination process and output; (2) as the moisture in the tightly closed cavity of the still increases upon solar heating the evaporation is reduced and the still becomes less efficient; (3) Some of the desalinated water that condenses on the lower side of the transparent cover is preferentially evaporated relative to the salty water in the basin because of its lower density and therefore less salty water is evaporated; (4) there is a problem of obtaining an efficient condenser for the solar still and reliance on the air temperature outside the still to condense the water is not efficient, and the transparent cover becomes hot itself and the temperature drop between the evaporating moisture and the cover is not significant enough to allow substantial condensation; and (5) the above factors result in a still that is expensive with a low output of 2-5 liters per square meter per day. It is therefore desirable to invent a solar desalination device that is less expensive and is more productive per unit of space per day.

### SUMMARY OF THE INVENTION

The desalination greenhouse is a solar still that doubles as a greenhouse. The desalinated water produced could be used for any purpose such as drinking, boiler water and chemical industry due to its high purity or for agriculture and any combination of the above as it is inexpensively produced. The structure is essentially a greenhouse with an additional inexpensive extra cover and with a side benefit of desalination. The capital cost is therefore appropriated primarily for the greenhouse crop product, and the capital cost of desalination is significantly reduced. The desalination greenhouse of the invention also provides a number of flexible operation controls to produce crops rapidly in a desert environment using brackish water. Both winter and summer operations can be optimized and the desalination greenhouse helps to compensate for changing exterior process operating conditions. Even more surprisingly the desalination greenhouse can produce a source of potable water given an input of only brackish or sea water.

The desalination greenhouse can be optimized for superior crop production and minimization of diseases. It minimizes heating and cooling requirements due to its superior insulation and absorption of heat in summer and its release in winter without obstructing natural light transmission. It uses renewable energy to desalinate water through condensation of sun and wind heated air that is forced through the cavity between the two structures to evaporate a very thin layer of water, and then to a black cover heated zone, to evaporative cooler wet pads. Condensation occurs on the inner surfaces of the outer and inner sections of the desalination greenhouse. Condensation of the inner greenhouse humid air may be achieved through a heat exchanger carrying the cooled water piped from the through of the evaporative cooling pads. The roof of the inner section of the desalination greenhouse is wetted evenly with sea or brackish water for evaporation which also cools the structure of the inner section of the desalination greenhouse. 1.0 to 10.0 mm v to u shaped grooves in the hard cover roof material of the inner section of the desalination greenhouse, preferably made of polycarbonate, guide the water downward and spread it evenly over the surface, providing the right depth for effective evaporation and cooling of the inner greenhouse. The inner greenhouse frame structure elements may be extended to support the outer greenhouse poly cover. The double shell greenhouse as described provides an efficient and cost effective means of heat utilization to desalinate sea or brackish water for irrigation and other uses, reduce heat input into the inner greenhouse, and minimize the crop requirement by over 95% by cutting the production cycle substantially and recovering the evapo-transpiration water.

The space over the water being desalinated is never saturated due to continuous air movement. The thickness of the salty water being evaporated is maintained very thin, within one centimeter, in order to chill the water to lower temperatures through evaporation and removal of moisture by the air. The even distribution of the salt water and its thin layer covering the roof and sides of the production greenhouse, made possible by the channel design (grooves) provides the production greenhouse with a cold surface that makes the environment more conducive to optimal plant growth and enhances condensation on the ceiling and sides of the production greenhouse. The outer shell greenhouse is a canopy to trap the moisture evaporating from the roof of the production greenhouse and enhances condensation on the ceiling and inside wall of the outer shell greenhouse.

An 1008 square meter floor greenhouse, for example, (36×28 and 4 meter high at the gutter and 8 meter high at the center) with one meter space between the inner and outer shell, has a total surface are of roof and sides of 2800 square meters allowing for doors and other vents. This area shall produce about 10 liters per square meter per day, or 28,000 liters per day. A seawater desalination greenhouse of a single shell (1), which relied on cold deep seawater as a condenser, produced between 3 and 6 liters per square meter per day depending on whether the environment is tropical or oasis. When the crop produced in the present desalination greenhouse invention is barley for animal forage production, the cycle per crop averages ten days from seed to harvest (2). The desalination greenhouse will produce 1500 tons of forage annually and consumes 4500 cubic meters of desalinated water per year for irrigation.

The desalination greenhouse of the current invention produces over 10,000 cubic meters of desalinated water, enough for forage irrigation and drinking water for 1000 people, each using 15 liters per day. The desalination greenhouse of the current invention could contribute to solving problems of many regions of the world that require desalinated water for human consumption, industry and irrigation of crops. The high value of the desalinated water makes it valuable for boiler and chemical process water which is expensive to produce and requires substantial energy due to its high level of purity.

The air cycle steps of the desalination greenhouse may be represented as follows: Ambient air>disinfection>filter>blower>distribution>roof humidification>heating>pad humidification>condensation>ambient air. The water cycle steps in the desalination greenhouse may be represented and summarized as follows: a) Salty water. Salty water spread over roof of production greenhouse>evaporation and cooling on roof>evaporation and cooling on evaporation pads or water shower>heat exchanger condenser>Collection and recycle with bleed and blend with fresh salty water; b) Desalinated water. Condensed water on inside and walls of outer shell+Condensed water on inside and walls of production greenhouse+condensed water on heat exchanger carrying cold water from evaporation pads

All condensate is collected in their own gutter like channels separate from salty water channels.

### BRIEF DESCRIPTION OF THE DRAWINGS

The invention, its configuration, construction, and operation will be best further described in the following detailed description, taken in conjunction with the accompanying drawings in which:

FIG. 1 is a perspective skeletal view of the desalination greenhouse of the present invention showing a nesting of the structures to create a separation space between an inner section and an outer section;

FIG. 2 is diagram of the structures within the desalination greenhouse which inlet air experiences during the expected operation;

FIG. 3 is a section taken along line 3-3 of FIG. 1 to illustrate the conversion of brackish water to potable water by condensation onto the inside surfaces of an outer section of the desalination greenhouse;

FIG. 4 is perspective of a panel having channels (grooves) in the plate surface which have a triangular cross-sectional shape to produce triangular channels, the plate used for roof and outer sides of the inner and outer shells of the desalination greenhouse;

FIG. 5 is cross sectional view of a plate which may or may not be the same overall size of the plate of FIG. 4, and illustrating a cross sectional profile having abbreviated height projections which define wide shallow channels;

FIG. 6 is cross sectional view of a plate which may or may not be the same overall size of the plate of FIG. 3, and illustrating a cross sectional profile having height projections which have a separation of about the same distance as their height;

FIG. 7 is a schematic of the components of a vortex system which is utilizable for cooling at one end and heating at the other in conjunction with the desalination greenhouse;

FIG. 8 is an expanded sectional view of the portion of the desalination greenhouse and illustrating separated vertical walls, and a fresh water reservoir feeding a system which includes heat exchange, storage, irrigation system storage and metered fertilizer; and

FIG. 9 is a perspective skeletal view of a stackable production bin which may be preferably used on a conveyor.

### DETAILED DESCRIPTION OF THE PREFERRED EMBODIMENT

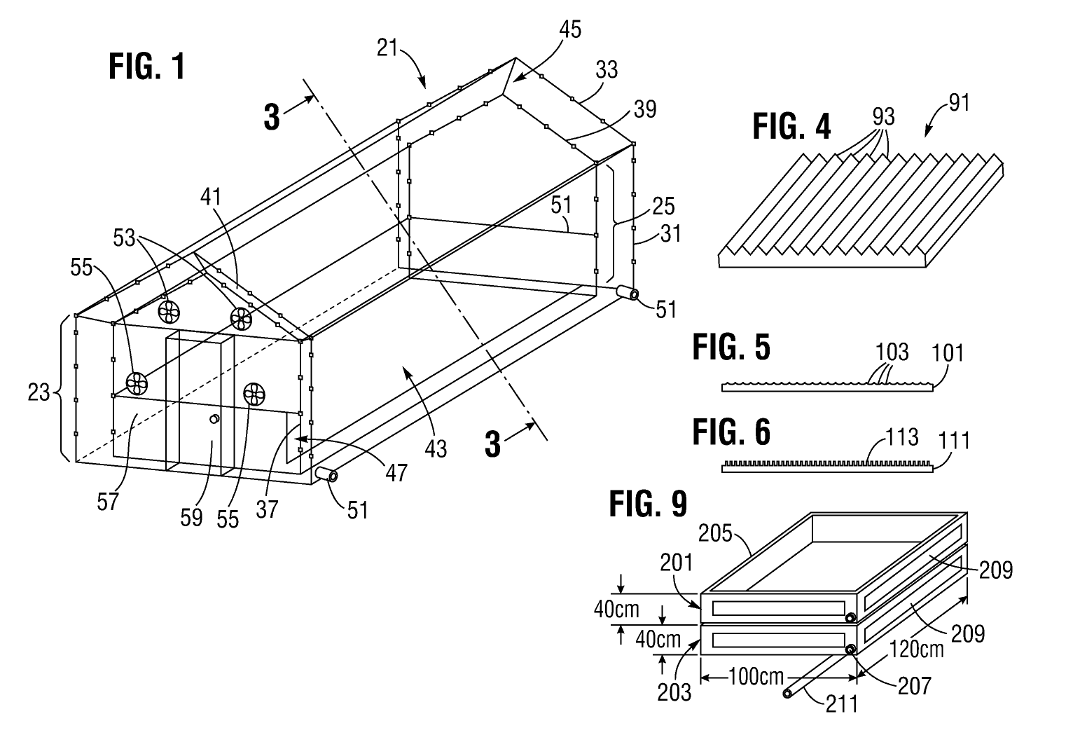

Referring to FIG. 1 a perspective skeletal view of one type of embodiment of a desalination greenhouse 21 which is shown as a long rectangular building, but need not be of the shape shown. The desalination greenhouse 21 is shown in a transparent view and includes an outer shell 23 for containment of water vapor, desalination, and light transmission; and inner shell 25 which is in effect an inner greenhouse, and is for crop production, evaporative cooling and condensation of moisture.

The outer shell 23 shown is of simple construction and includes a series of vertical walls 31 which include side walls and end walls and topped by a roof 33 which includes a pair of sloped roof walls. Likewise, inner shell 25 shown is of simple construction and includes a series of vertical walls 37 which include side walls and end walls and topped by a roof 39 which includes a pair of sloped roof walls. Roofs 33, 39 of both greenhouses are preferably similar to each other (although shown in FIG. 1 as being parallel), they need not be. Both the roofs 33, 39 have roof walls shaped with a slant angle more than 15 and less than 60 degrees to facilitate condensate gravitationally sliding downward. Outer shell 23 has an inner chamber 41 while inner shell 25 has an inner chamber 43. Inner chamber 41 contains the inner shell 25 and is smaller, with the annular space between the outer shell and inner shell being referred to as a cavity and including a roof cavity 45 between the roofs 33 and 39 and a side cavity 47 between the vertical walls 31 and vertical walls 37.

Any number and type of protruding supports 51 may be anchored to the structural body of either of the outer shell 23 or inner shell 25 and for the purpose of anchoring the desalination greenhouse 21, securing the outer shell 23 or inner shell 25 to each other, or for anchoring the outer shell 23 to the ground, with FIG. 1 being a skeletal view to show the nested relationship of the outer shell 23 and inner shell 25. Differing construction materials and methods of support, such as positive air pressure and the like, can be used to construct the desalination greenhouse 21. Supports 51 may include any frame member, as well as any member from which external or internal support may be facilitated by any other structure or object. Also, the desalination greenhouse 21 has been recited in terms of an outer shell 23 and an inner shell 25 such that roof and side cavities 45 and 47 can be available to promote condensation in the outer shell. It is understood that, especially for desalination greenhouse 21 which are much longer than they are wide, that the ends can be similarly situated to have a side cavities along with some portal access such as a door bridge to extend between them, but that in a long desalination greenhouse 21 most of the action will occur between side cavities 47 of the major long sides of the desalination greenhouse 21, as well as the roof cavities 45.

FIG. 1 illustrates a crude schematic possible location for a pair of air inlet air moving devices such as fans 53 shown, but not necessarily forced to be located nearer the roof 33, which force outside air into the roof and side cavities 45 and 47. A pair of exhaust or outlet air moving devices, such as fans 55 are shown, but not necessarily forced to be located, in the middle of an end vertical wall structure 57, and connect inner shell 25 inner chamber 43 to the outside atmosphere. Vertical wall structure 57 may include a door 59. The further details of an entry door 59 will be omitted, but suffice it to say that door 59 may be located in a connective portal which engages both the outer shell 23 and inner shell 25 to disrupt any breach or interruption of the roof and side cavities 45 and 47. In this way, a single door 59 can be operated to give access to the inner chamber 41.

Conversely, a separate door may be provided for each of the outer shell 23 and inner shell 25, with the space between the two doors remaining an active part of the roof and side cavities 45 and 47. This may not be as preferred as the opening of either of two such separate doors would disrupt the action and flow going on in the roof and side cavities 45 and 47. When access to the inner chamber 41 is had over a long time, such as the introduction or removal of soil and plant materials, the roof and side cavities 45 and 47 would be significantly disrupted. In yet a further alternative, the end wall 57 may be designed not to contain a side cavity 45 and to be built as a wall and support structure common to both the outer shell 23 and inner shell 25. In this case, the user is giving up the desalination action at the end wall 57. However, as can be seen in FIG. 1, and in the end wall 57 and roof portion of end wall 57 supports four fans 53,57 and a door 59 which combine to occupy a significant percentage of the end wall 57. It may thus be desirable for simplicity of construction for doors 59 and fans 53, 57 to be located in an isolated cluster which will enable the use of a single wall to thus eliminate the need for double sealing, and accommodating other insulatory structures to enable the action to be described in the roof and side cavities 45 and 47 around such access accommodating and insulatory structures.

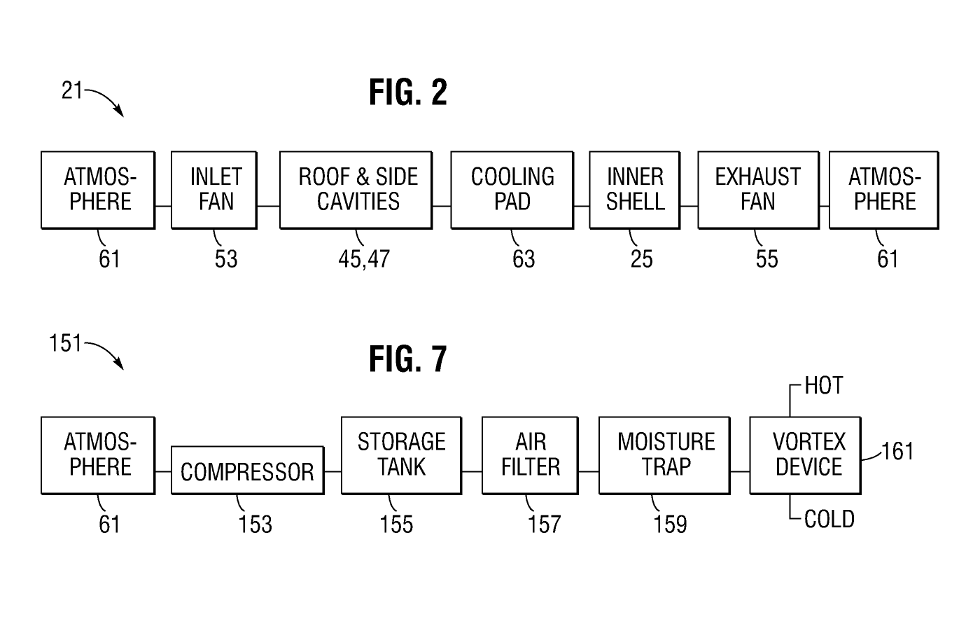

With the basics of an overall structure of an example desalination greenhouse 21 having been seen in FIG. 1, and without the need to make duplicative burdensome specifically located structures to illustrate the operation of the desalination greenhouse 21, a diagrammatic representation of the overall flow is shown in FIG. 2. Referring to FIG. 2, a block diagram illustrates the general flow of air through the desalination greenhouse 21. From the outside atmosphere 61, air may be drawn in through forced air fans 53. Where the desalination greenhouse 21 is much larger than the simple design of FIG. 1, the inside of air fans 53 may be fitted with a distribution duct to insure that the incoming forced air from the atmosphere is spread as evenly as possible through the roof cavity 45, even to the most distant portion of the desalination greenhouse 21. It is understood that even though the general structure of the desalination greenhouse 21 is oblong, that if a desalination greenhouse 21 was wider than long, there may be several forced air fans 53 operating with generally parallel hot air distribution lines (not shown). In the case of a single, extraordinary long desalination greenhouse 21, a large forced air fan 53 might be used with a significant sized ambient air distribution pipe or duct (not shown).

The forced air fans 53 introduce ambient air into the roof and side cavities 45 and 47 throughout the desalination greenhouse 21. The hot air will be utilized to evaporate and possibly cool any saline or brackish water which may be introduced onto the surface of the outside of the inner shell 25. The air circulating in the roof and side cavities 45 and 47 whose humidification may be increased after contact with moisture from the outside of the inner shell 25 may deposit some fresh water droplets via condensation on the inside of the outer shell 23. The air circulating in the roof and side cavities 45 and 47 whose humidification may be increased after contact with moisture from the outside of the inner shell 25 may then proceed into the inside of the inner shell 25 through an optional cooling pad 63. Cooling pad 63 may be a matrixed structure which entrains some liquid to facilitate an increased contact between air circulating in the roof and side cavities 45 and 47 and liquid water which may be present in the cooling pad 63 through a variety of mechanisms.

The cooling pad 63 can be a passive fibrous flow device to enable a passing gas to make a greater degree of contact with a wetted area. Cooling pad 63 can include a recycle branch to collect and recirculate liquid which typically passes through it from top to bottom. Cooling pad 63 may also be connected to external heating sources or cooling sources (not shown in FIG. 2) which provide thermal transfer through a conduit such as a heating coil or cooling coil. Cooling pad 63 also, regardless of whether or not connected to external heating or cooling sources, can act as a stabilizing passive heating or cooling mass to protect plants within the inner shell 25 from momentary changes such as between full sun and cloud cover, as well as between day and night. Physically, the cooling pad 63 may likely be located within the inner shell 25 and likely beginning at the boundary between the inner shell 25 and the roof and side cavities 45 and 47 and continuing into the inner shell 25 for a sufficient distance (typically horizontal distance) to provide adequate contact between the air flow entering the inner shell 25 and any wetted surfaces within the cooling pad 63.

Air which emerges from the cooling pad 63 enters the inner shell 25 which it is available to humidify and provide gentle and stable appropriate temperature air for any growing plant matter located within the inner shell 25. The air from the cooling pad 63 may be arranged for maximum circulation within the inner shell 25, including other circulating fans, such as ceiling fans and blowers, located within the inner shell 25. From inner shell 25, the air passes to and through exhaust fan 55 and back to the atmosphere 61. It may be preferable for inlet fan 53 to operate at a higher pressure rate than exhaust fan 55 so that the air within the outer shell 23 and inner shell 25 may be somewhat slightly pressurized.

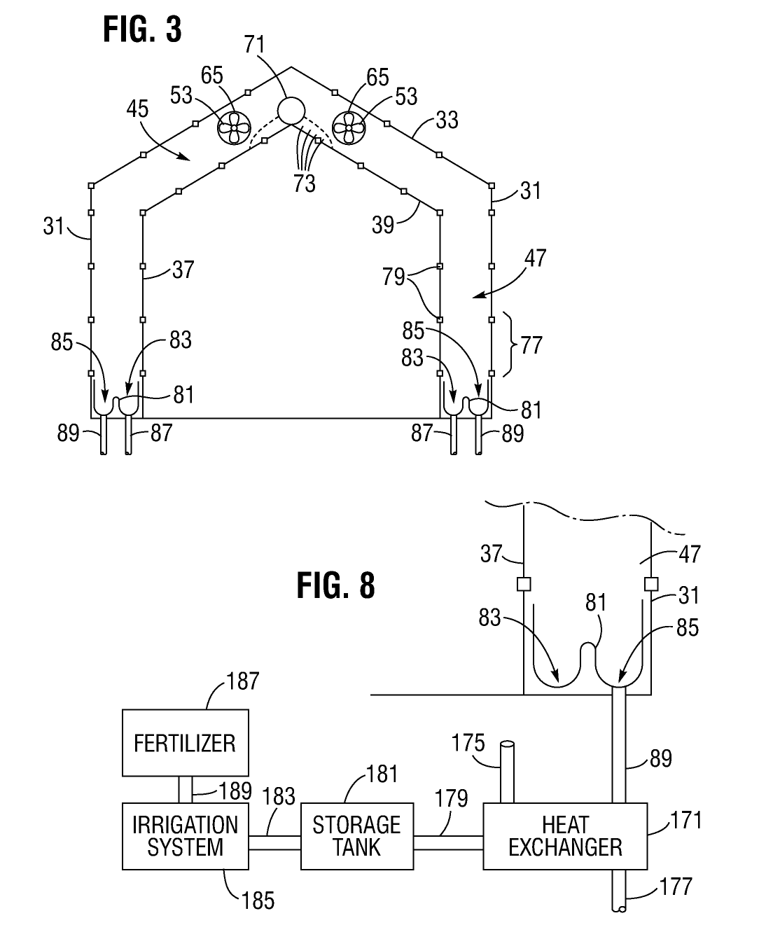

Referring to FIG. 3, a schematic view taken along line 3-3 of FIG. 1 shows some operational details of desalination greenhouse 21. The previously seen inlet fan 53 is seen as blowing air into a conduit or duct 65 which continues to extend along a significant length of the rectangular elongate shape of the desalination greenhouse 21. Duct 65 may be a wide plastic pipe and may be configured to be heated by the sun. The relationship of the roof 33 and roof 39 separated by the roof cavity, and the relationship of the vertical walls 31 and vertical walls 37, separated by the wall cavity 47 is better illustrated. Above a top portion of the roof 39, a brine distribution header pipe 71 is seen as having ability to distribute, drip, spray or otherwise convey in any manner, brine 73 in an even as distribution as possible to coat and move slowly across the roof 39 and thence walls 37 of the inner shell 25. As will be shown, the materials of construction of both the inner shell 25 and outer shell 23 are so as to promote an enhanced holding time for brine 73 so that it will have an opportunity to evaporate from the exterior of the inner shell 25 and condense on the inside of the outer shell 23.

Not shown in FIG. 1 were details of construction of the desalination greenhouse 21 as the details of other structures would have been obscured. The materials of construction for the inner and outer shells 25 and 23 of the desalination greenhouse 21 may include a plurality of uprights 77 and cross bars 79 to support panels (not yet shown) which may be replaced if damaged or broken. Uprights 77 and cross bars 79 may be made from galvanized steel, aluminum or other suitable material. In the perspective of FIG. 3, some of the uprights 77 are shown as segments between the cross bars 70 which are shown as expansions located along the uprights 77. It is also noted that the walls 31 and 39 need not be vertical, but may be sloped or curved. Any sloping and curving of the walls 31 and 39 may be configured to combine with the shape of the roofs 31 and 39 to produce an advantageous gravity and slope controlled flow.

Explained, the exterior of inner shell 25 will have an even flow of brackish water or brine 73 over its exterior surface. Any energy input into the inner shell 25 will cause water to be vaporized. Vaporized water may condense on the inside of the outer shell 23 and run down the inside of the roof 33 and down the inside of wall 31. At the base of the walls 37 and 31, the clean condensed water from the inside of wall 31 would otherwise mix with the brackish water, or brine 73 flowing down from the outside of wall 37. The prevention of mixing of these two streams by segregating and conserving the pure condensed water provides a source of desalinated water. A barrier 81 separates the flow at the base of the walls 31 and 37 into a brackish water reservoir 83 and a fresh water reservoir 85. Brackish water reservoir 83 may have a lower drainage tap 87 and a fresh water reservoir 85 may have a drainage tap 89. Taps 87 and 89 will assist in harvesting and or recycling the brackish water 73 or the condensed water as needed.

Referring to FIG. 4, a panel 91 is shown which has a series of channels or grooves 93 seen in parallel across the upper surface of the panel 91. When the panel 91 is arranged so that the grooves 93 extend horizontally, the grooves act to entrain some of the brackish water 73 and hold onto it while giving it an opportunity to evaporate. At minimum, the grooves 93 increase the effective vertical height of the walls 37 and optionally the flow path length along the roof 39. At best, the grooves 93 could be angled unevenly to form little “shelves” each of which could provide a significant residence time for brackish water 73 on its way to brackish water reservoir 83. In some cases the grooves 93 could even have a negative load flanking to form a horizontal drainage channel with or without interruptions in a horizontal to even further increase the mean flow path. In other words, if every other groove were “nicked” at its end, and if the upper angle were less than horizontal, brackish water 73 could be caused to follow a serpentine path down the panel 91. Other variations are possible.

The panel 91 may be made of conventional greenhouse building material products such as plastic, polycarbonate, or any other material which is at least partially clear. The grooves 93 may be formed by molding or by matching or by other technique. An outer covering may be of lighter materials such as polyethylene for economics and for easy removal when cleaning of the roof 33 is needed. Air and water within the desalination greenhouse 21 may be uv-disinfected at any, and at many points in the system for to enable the use of an organic crop label for plants grown. Referring to FIG. 5, and as a further variation on panel 91 of FIG. 4, an end view of a panel 101 is shown as having a series of spaced apart and low profile protrusions 103. Likewise, Referring to FIG. 6, and as a further variation on panel 91 of FIG. 4, an end view of a panel 111 is shown as having a series of spaced apart and high profile protrusions 133 to form a series of rectangular channels approximately as wide as the protrusions are tall.

The use of a vortex system could be employed with the desalination greenhouse 21. Referring to FIG. 7, a schematic block diagram of such a system is shown. A vortex system 151 includes equipment to make a process flow of air. A vortex diverter system 151 is used for heating on one end and cooling on the other and which may be controlled to increase or decrease as required. A compressor 153 pressurizes air into an air storage tank 155 at about 100 PSI. The pressurized air exits from the tank 155 and passes through an air filter 157 and a moisture trap 159 before it inters a vortex device 161. The vortex device 161 splits the air into cold stream exiting from one end of the vortex device 161 and hot exiting from the other end of the vortex device 161. The hot air output of the vortex device 161 may be introduced into the duct 65 either upstream or downstream of the inlet fans 53 where it will ultimately enter the roof and side cavities 45 and 47. The cold air output of the vortex device 161 may be passed through a coil or other heat exchange structure inside a water pipe (not shown) carrying the cold water to the inner shell 25 of the desalination heat exchanger 21. In the summer when more cold air from the output of the vortex device 161 is needed to condense more water, the cold portion of the air is increased which will decrease the warm output of the vortex device 161. In winter the arrangement is reversed as more hot air from the vortex device 161 is needed for introduction of heated air duct 65 either upstream or downstream of the inlet fans 53. Mechanical controls on each end of the vortex device 161 outlets facilitate adjustment of heat and cold flow. In instances when the air filter 155, and heat and residence time in the vortex system 151 do not disinfect enough, the air passing into black, heat absorbing conduit or duct 65 can provide some additional sterilization.

In general, the use of a vortex system could be employed with the desalination greenhouse 21. The cool air under positive pressure from the air blower 153 will eventually enters inner shell 25 through evaporation or cooling pads 63. Cooling pads 63 may be switched off by either being taken out of the path of flow or simply allowed to run dry, to remove its ability to cool inner shell 25 of desalination greenhouse 21 using cooled air from roof and side cavities 45 and 47. Conversely, cooling pads 63 may be switched on or into or out of the path of flow and with the brine distribution header pipe 71 used wetting roof 39 and side walls 37 of inner shell 25 of desalination greenhouse 21 with roof and side cavities 45 and 47 switched off or isolated from flow, in humid climates so that heating the air reduces its relative humidity and makes it effective in cooling inner section 24 of desalination greenhouse 21. Cool air then passes from roof and side cavities 45 and 47 into inner shell 25 of desalination greenhouse 21 to cool the growing crop, to enable the growing crop to transpire, supply oxygen and remove carbon dioxide and other gases. Air becomes warmer and more humid as it passed from one end of to the other of inner shell 25 of desalination greenhouse 21 due to the incident light and heat and transpiration of the crop in inner shell 25 of desalination greenhouse 21. Air may exit inner shell 25 of desalination greenhouse 21 through a heat exchanger (not shown in FIG. 7) through which cold water is circulated. The air loses its moisture to heat exchange and exits to ambient environment or fed to the inlet of the inlet fan 53 feeding roof and side cavities 45 and 47. An advantage of circulating air is to reduce dust and germ, insects, seed and other undesirable foreign matter into desalination greenhouse 12. Ultra-violet disinfectant 80 helps classify a crop as organic as no chemical disinfectants or herbicides are used.

Referring to FIG. 8, a portion of a possible flow scheme utilizable in conjunction with the desalination greenhouse 21 is shown. A section including the inner shell 25, outer shell 23 and barrier 81 is shown with a connection to drainage tap 89. Drainage trap 89 can be connected into a heat exchanger 171 which can be used dehumidify the humid warm air exiting inner shell 25 before being discharged to atmosphere. An air inlet 175 is shown and which may optionally be connected either upstream or downstream of the exit fan 55 seen in FIG. 1. An air outlet 177 would typically be vented directly to atmosphere 61. A number of shutoff and bypass valves, storage tanks and piping (not shown) may be used to shutoff, bypass water flow to any of the devices when not in use and store water.

Heat exchanger 171 exit condensate is preferably collected through exit line 179 and is piped to an insulated underground cold water storage tank 181. A portion of the desalinated water is transferred by pipe 183 to an insulated underground irrigation tank 185 tank used as an irrigation reservoir. Well balanced fertilizers that include macro and micro nutrients required by the crops may be contained in a fertilizer tank 187 are dosed into the irrigation tank and are topped as the crop uses the fertilizers through a dosing line 189. One possible method of hydrating the plants may involve cold irrigation water is fed to the crop through piping that connects to soaker hoses laid in parallel under the crop. Excess irrigation water may be drained to the irrigation system tank 185 which is topped with fertilizers and desalinated water as needed.

Referring to FIG. 9, a stack of two growing trays, including growing tray 201 and growing tray 203 are shown in stacked relationship to emphasize the efficiency which can be achieved in conjunction with the desalination greenhouse 21. The growing trays 201, 203 contain the sprouted seeds to grow the crop. The growing trays have edges 205 which may overlap so as to contain irrigation water within the trays 201,203. Trays 201, 203 may each have a drainage hole 207 and several openings 209 to admit light to promote growth even though the trays 201,203 may be in stacked position. One set of dimensions that may work well for a given growing tray 201 may include a width of about 100 centimeters, a depth of about 120 centimeters, and a depth of about 40 centimeters.

The growing trays 201, 203 may also extend along the same direction as a soaker hose 211. Soaker hoses 211 may extend along the length of the desalination greenhouse 21 and may be fed with cold water from fertilizer added irrigation system 185 seen in FIG. 8. Several soakers hoses 211 may connect to a header for pressure equalization. Soaker hoses 211 may also deliver a desalinated water rich in nutrients in the form sprayed fog. Irrigation frequency is scheduled to provide the crop with adequate irrigation water, without excess, during, for example, a 10-14 day growth cycle, for forage production. Using the growing trays 201, 203 shown and soaker hose 211 shown, the root mat for plants grown will be removed with the crop during harvest.

In terms of overall process operations, the water for feeding crops is typically the desalinated water which originates at the inside surface of the outer shell 23 of the desalination greenhouse 21 resulting from evaporating of sprayed brackish water 73 using relatively hot air within roof and side cavities 45 and 47 and producing, condensation of inside of roof 33 and sides 31 of desalination greenhouse 21 resulting from evaporation of sprayed brackish water 73 onto the roof 39 and walls 37 of the inner shell 23 of the desalination greenhouse 21 and possibly from cooling pads 63 when operating and evapo-transpiration of the crop. Condensate from vertical walls 31 of the outer shell 23 are collected in a fresh water reservoir 85 which is preferably separated from a brackish water reservoir 83 such as by a barrier 81 as was shown in FIG. 8. Desalinated water may be collected in an insulated underground storage tank 181 and utilized both for crop watering and as a source of fresh water.

In terms of process, and in further detail as to operation, air forced by inlet fans 53 are distributed evenly throughout the roof and side cavities 45 and 47. When this air is heated, it evaporates sea or brackish water 73 on the exterior surface of the inner shell 25. Downward flow of brackish water 73 is delayed by grooves 93, 103 or 113 of panel 91, 101, 111 which make up the roof 39 and side outer surfaces of vertical walls 37, except for doors 59 and vents associated with the inlet and exit fans 53 and 55. Transparent roof 33 of outer shell 23 of the desalination greenhouse 21 preferably passes maximum light and heat to roof and side cavities 45 and 47. Roof 39 and vertical sides 37 of inner shell 25 of desalination greenhouse 21 is wetted with a thin sheet of brackish water 73, of about two centimeters or less thick, fed from a source of sea or brackish water 73 from brine distribution header pipe 71 by a low pressure pump and spread evenly as guided by grooves 93, 103 or 113 of panel 91, 101, 111. Cool air from to roof and side cavities 45 and 47 produced by hot air giving up its heat to vaporize water, especially where brackish water 73 is heated in a black lining sun exposed section of the outer section of the desalination greenhouse 21. As inlet air is heated its relative humidity drops. It then passes through the cooling pads 63 where it may pick up more moisture and cools the inner shell 25 of desalination greenhouse 21. Brackish water 73 on the roof 39 of inner shell of desalination greenhouse 21 is cooled through evaporation and transmits this cooling effect through panel 91, 101, 113 to the inner shell 23 of desalination greenhouse 21 to aid in the cooling of the crop environment and condensation of moisture on the inside of the outer section 23 of the desalination greenhouse 21. Cool air is blown into inner chamber 43 through the cooling pads 61.

When roof 39 of the inner shell 25 is not wetted, as in winter when crop water requirement and cooling are not required, hot air passes through water soaked cooling pads 61 to pick up moisture to produce cool air within inner chamber 43 and to produce cold water where a coil is provided in the cooling pad 61. Cool air will then exit evaporative cooling pads 61 into the inner chamber 43 of the inner section 25 of the desalination greenhouse 21 to cool growing crops and then exit through exhaust fans 55 which operate at lower pressure than forced air fans 53 to maintain positive pressure in both the inner chamber 43 and the roof and side cavities 45 and 47. In the alternative, exhaust fans 55 can be minimized or eliminated with certain designs, particularly a passive exit where overall pressure and air flow in the desalination greenhouse 21 is maintained high.

The forage crop production system in the desalination greenhouse 21 is and can be a 24/7 production system. A quantity of the seeds, depending on the size of the growing tray 201, may be soaked in disinfected water for 24 hours, then drained and covered to germinate in a pail or other container. The seeds may be irrigated with mist nutrient twice a day. Within 3-4 days the germinated seed may be spread in a growing box such as growing tray 201 and placed on a conveyer belt or rollers. The growing trays 201 may be stacked 4-6 high to utilize the inner chamber 43 of the desalination greenhouse 21 effectively. The growing trays 201 may have openings 207 on the sides for light, ventilation and irrigation. The growing trays 201 may be irrigated with a mist of nutrient rich desalinated water. A conveyor built/roller (not shown) can be operated daily to move ⅛ to 1/10 the distance per day so that a crop has an automated harvest indication each day after it has been on this type of moving belt for 8 to 10 days.

The crop, including the roots, may be tipped from the growing tray 201 and into a tub grinder which may cut or otherwise process the crop and feeds it into a wagon or conveyance to be transported fresh to its needed consumption point, such as to a grazing animals for feeding. A typical desalination greenhouse if 1000 square meters area, producing 4 tons of barley forage per day. It will use 50 cubic meters of sea or brackish water per day compared to 10,000 cubic meters per day in field production of sweet water. The energy requirement is 96 KWH per day for the fans. Conventional Reverse Osmosis desalination alone will require 200-400 KWH per day.

Controls of the desalination greenhouse 21, not shown, may be used to control the equipment set forth and other equipment. Equipment controlled includes ventilation, evaporative cooling, spraying and use of both fresh and brackish water, irrigation, vortex device 161 operation, warning systems, pumps and other functions. The advantages of desalination greenhouse 21 are to desalinate brackish water 73 for potable and agricultural use and insulation property of two preferably transparent bodies, as the bulk of the internal and external shells 25 and 23, with air in between within roof and side cavities 45 and 47 which enables a level of control and combine to save major running expenses compared to conventional greenhouse operation. The brine distribution header pipe 71 sprinkling system within the roof and side cavities 45 and 47 creates a sheet of water on the roof 39 and vertical walls 37 of inner shell 25 of desalination greenhouse 21 further insulating it without obstructing light transmission and while cooling inner chamber 43 of desalination greenhouse 21. The superior properties of water to absorb heat to the extent of 540+ calories per cubic centimeter (cc) when evaporating is an effective cooling mechanism in summer while the outer shell 23 of desalination greenhouse 21 insulates it from cold and snow in winter. Such arrangement exemplified in the desalination greenhouse 21 saves energy and is environmentally friendly.

Another advantage of desalination greenhouse 21 is the use of the crop growing structure of inner shell 25 of desalination greenhouse 21 as a support structure for the cover of inner shell 25 of desalination greenhouse 21. Cooling of crop roots using soaker hoses 211 is another advantage of desalination greenhouse 21 for the crop shoots to be enabled to tolerate higher temperatures in their potentially high temperature growing environment. An additional advantage of desalination greenhouse 21 is the ability for sterilization of the air through heat and ultraviolet treatment which enables desalination greenhouse 21 to grow organic crops and reduce insecticide use. A further advantage of desalination greenhouse 21 is use of natural lighting while providing a general thermal insulated inner section 25 of desalination greenhouse 21.

Another advantage of desalination greenhouse 21 is the heating of air for use for effective evaporative cooling where it would otherwise be ineffective in humid areas. A further advantage of the desalination greenhouse 21 is the flexibility and efficiency of using many features independently, especially heating and cooling which contributes to an overall cost reduction. A further advantage of the desalination greenhouse 21 is the use of renewable energy for some or all of its operations. The aforementioned advantages makes the desalination greenhouse 21 simple to operate and competitive especially in developing countries where fuel is expensive and potable water may not be available.

While the present invention has been described in terms of a desalination greenhouse 21 and components which can be used with control to affect (1) fresh water production, (2) quick crop growing times, (3) combination summer and winter operating configurations, the construction and process operation of a desalination greenhouse within the teaching above can be used to make a wide variety of alternate variations thereof.

Although the invention has been derived with reference to particular illustrative embodiments thereof, many changes and modifications of the invention may become apparent to those skilled in the art without departing from the spirit and scope of the invention. Therefore, included within the patent warranted herein are all such changes and modifications as may reasonably and properly be included within the scope of this contribution to the art.

What is claimed:

1. A desalination greenhouse comprising:
an outer shell structure for containment of water vapor, desalination, and light transmission, and having an inwardly directed surface and an outwardly directed surface and an inner chamber;
an inner shell structure carried within the inner chamber of the outer shell structure and having an inwardly directed surface and an outwardly directed surface and creating a cavity between the outer shell structure and inner shell structure;
an inlet air mover which introduces atmospheric air into the cavity between the outer shell structure and inner shell structure; the inner shell structure having an air inlet for accepting a flow of air from the cavity between the outer shell structure and inner shell structure and into the inner shell structure and the inner shell structure and outer shell structure having an outlet for outputting a flow of air from the inner chamber of the inner shell structure and outputting the flow of air from the inner chamber to atmosphere;
a supply of brackish water onto a surface of the inner shell structure to enable evaporation of water from the surface of the inner shell structure and promote condensation of water onto the inwardly directed surface of the outer shell.

2. The desalination greenhouse as recited in claim 1 and further comprising an outlet air mover for promoting removal of air from the inner chamber of the inner shell structure and from the inner chamber to atmosphere.

3. The desalination greenhouse as recited in claim 1 in which the condensation of water is 10 liters of distillate per square meter of outer shell structure per day.

4. The desalination greenhouse as recited in claim 1 in wherein the supply of brackish water onto the outwardly directed surface of the inner shell structure forms a layer of brackish water of about 0.5-5.0 cm thick when forced hot air blows over it to cause evaporation and lowering of temperature.

5. The desalination greenhouse as recited in claim 1 in which the outwardly directed surface of the inner shell structure carries a plurality of grooves for entraining some of the brackish water to facilitate the brackish water's opportunity to evaporate.

6. The desalination greenhouse as recited in claim 1 in which a portion of the outwardly directed surface of the outer shell structure is black for enhanced solar heat absorption.

7. The desalination greenhouse as recited in claim 1 and further comprising a cooling pad between the cavity which exists between the outer shell structure and inner shell structure, and the inner chamber of the inner shell structure.

8. The desalination greenhouse as recited in claim 1 and further comprising a fresh water reservoir adjacent the inwardly directed surface of the outer shell structure for collection of condensed water from the outer shell structure.

9. The desalination greenhouse as recited in claim 8 and further comprising:
a heat exchanger having a liquid inlet connected to said the fresh water reservoir and a liquid outlet;
a storage tank having an inlet connected to the liquid outlet of the heat exchanger and an outlet; and
an irrigation system having an inlet connected to the outlet of the storage tank and for providing water to at least one growing crop within the inner shell of the desalination greenhouse.

10. The desalination greenhouse as recited in claim 9 and further comprising a fertilizer supply connected into the irrigation system.

11. The desalination greenhouse as recited in claim 9 and wherein the irrigation system delivers water and nutrients in the form sprayed fog.

12. The desalination greenhouse as recited in claim 1 and wherein the outer shell structure includes an angled roof supported by walls.

13. The desalination greenhouse as recited in claim 1 and wherein inner shell structure includes panels supported by a plurality of uprights and cross bars and where the panels each include a plurality of outwardly disposed grooves for entraining some of the brackish water to facilitate the brackish water's opportunity to evaporate.

14. The desalination greenhouse as recited in claim 9 and further comprising an outlet air mover adjacent the outlet for outputting a flow of air from the inner chamber of the inner shell structure for facilitating the outputting the flow of air from the inner chamber to atmosphere.
